(19) United States
(12) Patent Application Publication
(10) Pub. No.: US 2015/0289462 A1
(43) Pub. Date: Oct. 15, 2015

(54) Plant Life Feeding Assembly

(71) Applicant: Richard Guldin, Lancaster, CA (US)

(72) Inventor: Richard Guldin, Lancaster, CA (US)

(21) Appl. No.: 14/248,401

(22) Filed: Apr. 9, 2014

(51) Int. Cl. A01G 29/00

(52) U.S. Cl. CPC A01G 29/00

(57) ABSTRACT

A plant life feeding assembly for delivering a fertilizer suspension to a root system of a plant includes a feeding member positionable within a support surface. The feeding member is positioned proximate a root system of species of plant life. The feeding member is substantially hollow. The feeding member has a plurality of fluid apertures extending therethrough. A filling member is operationally coupled to the feeding member. The filling member extends upwardly out of the support surface. The filling member is substantially hollow. The filling member receives a fluid fertilizer. The fluid fertilizer is distributed through the plurality of fluid apertures to the root system of the plant.

### BACKGROUND OF THE DISCLOSURE

### Field of the Disclosure

The disclosure relates to plant life feeding devices and more particularly pertains to a new plant life feeding device for delivering a fertilizer suspension to a root system of a plant.

### SUMMARY OF THE DISCLOSURE

An embodiment of the disclosure meets the needs presented above by generally comprising a feeding member positionable within a support surface. The feeding member is positioned proximate a root system of species of plant life. The feeding member is substantially hollow. The feeding member has a plurality of fluid apertures extending therethrough. A filling member is operationally coupled to the feeding member. The filling member extends upwardly out of the support surface. The filling member is substantially hollow. The filling member receives a fluid fertilizer. The fluid fertilizer is distributed through the plurality of fluid apertures to the root system of the plant life.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a plant life feeding assembly according to an embodiment of the disclosure.

FIG. 2 is a left side perspective view of an embodiment of the disclosure.

FIG. 3 is a front perspective view of an embodiment of the disclosure.

FIG. 4 is a bottom perspective view of an embodiment of the disclosure.

FIG. 5 is an cross sectional view taken along line 5-5 of FIG. 1 of an embodiment of the disclosure.

### DESCRIPTION OF THE PREFERRED EMBODIMENT

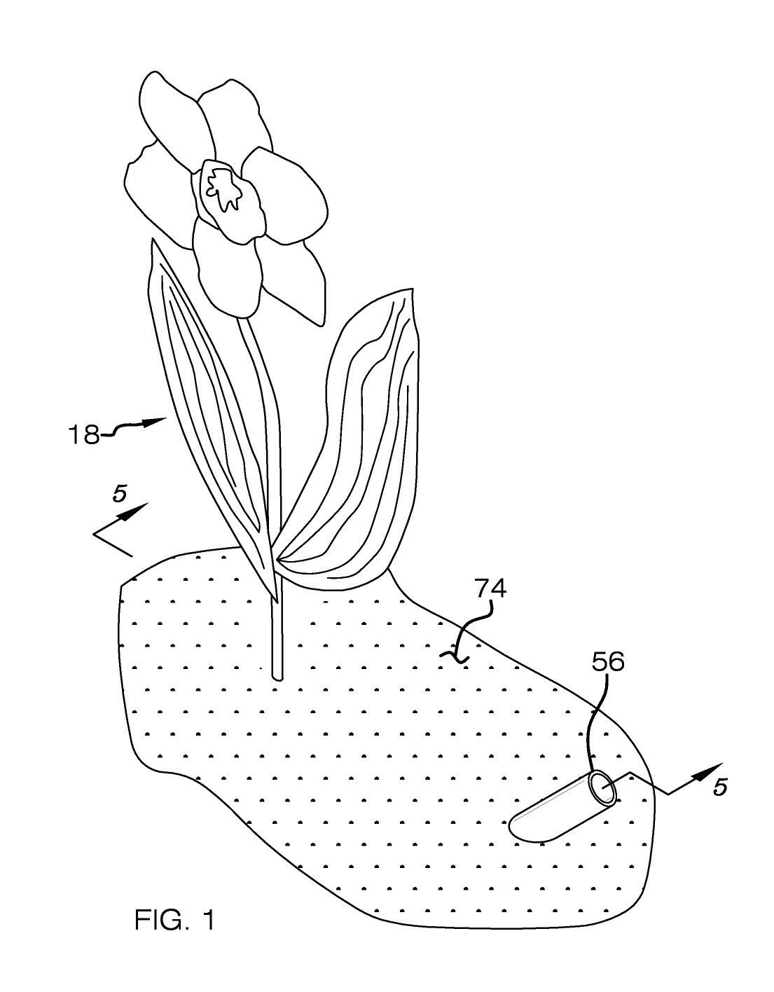

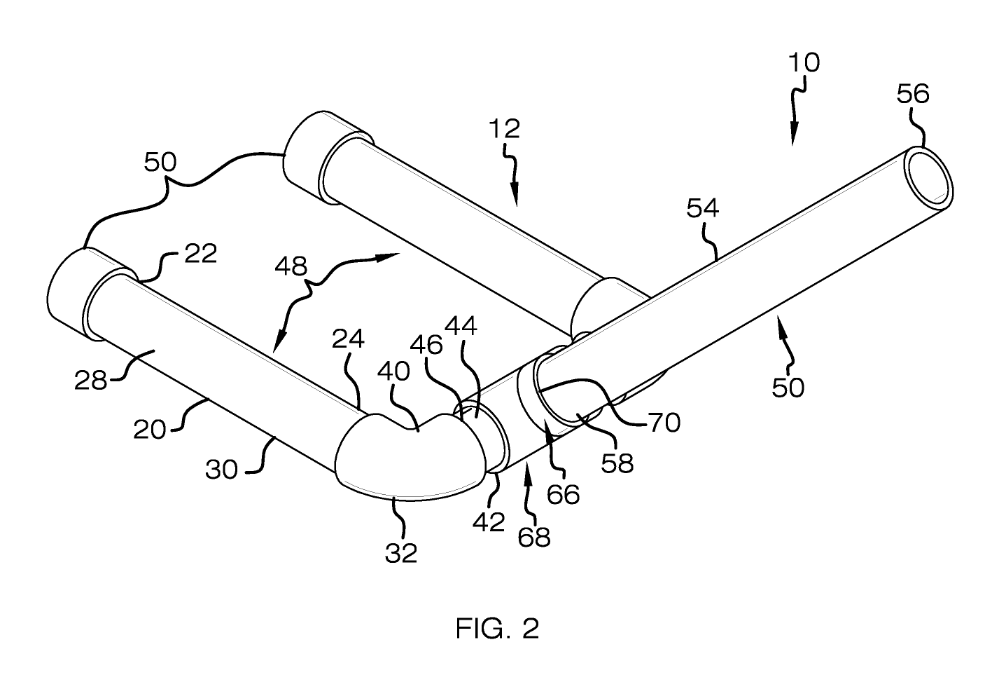

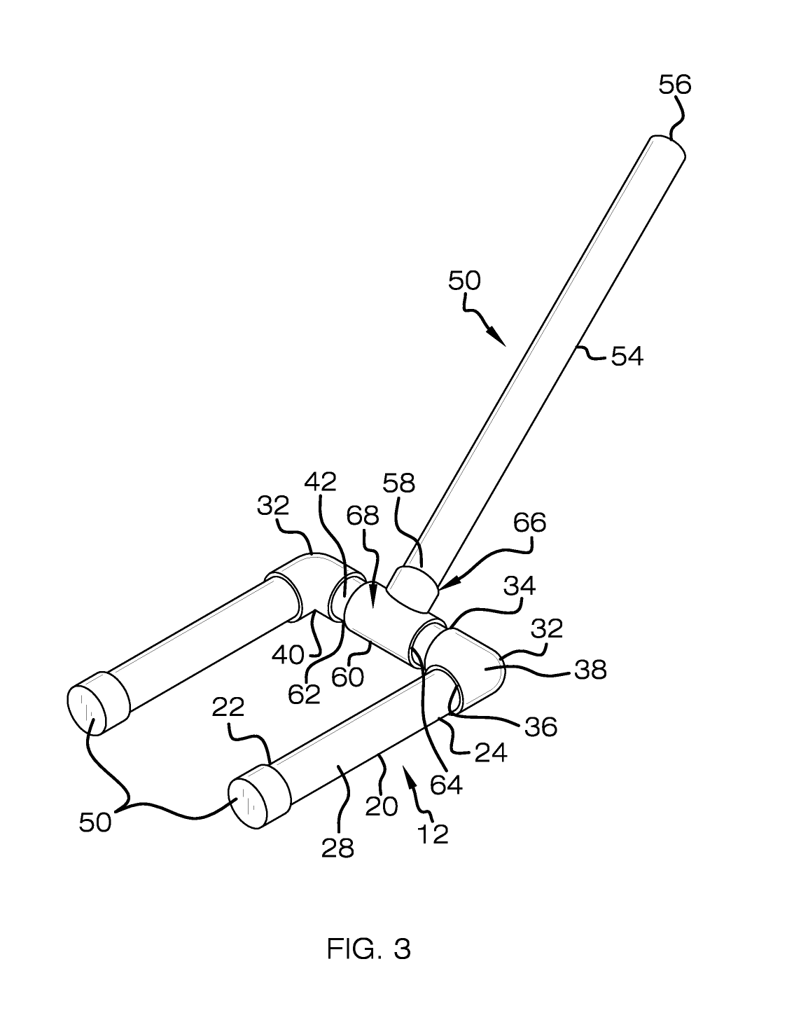

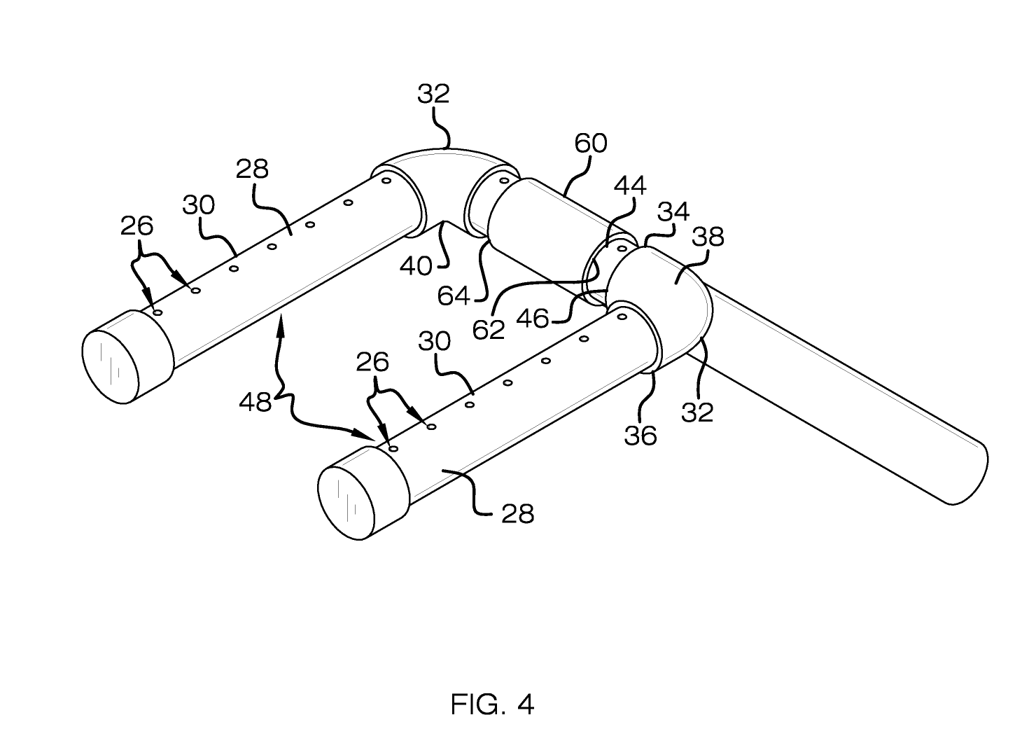

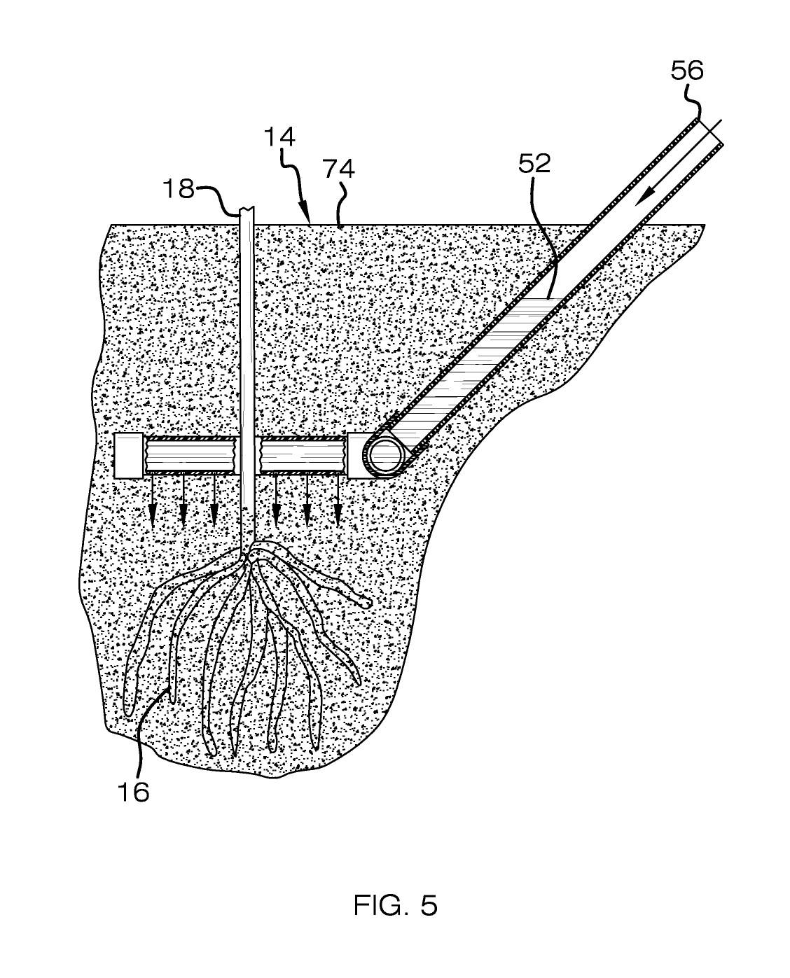

With reference now to the drawings, and in particular to FIGS. 1 through 5 thereof, a new plant life feeding device embodying the principles and concepts of an embodiment of the disclosure and generally designated by the reference numeral 10 will be described.

As best illustrated in FIGS. 1 through 5, the plant life feeding assembly 10 generally comprises a feeding member 12 that is positionable within a support surface 14. The support surface 14 may be ground. Moreover, the feeding member 12 is positioned proximate the root system 16 of a species of plant life 18. The plant life 18 may be an angiosperm. Additionally, the feeding member 12 is substantially hollow.

The feeding member 12 includes a distribution tube 20 that is elongated between a first end 22 and a second end 24 of the distribution tube 20. Each of the first 22 and second 24 ends of the distribution tube 20 is open. The distribution tube 20 has a plurality of fluid apertures 26 extending through an outer wall 28 of the distribution tube 20. Additionally, the plurality of fluid apertures 26 is positioned on a bottom side 30 of the outer wall 28 of the distribution tube 20. The plurality of fluid apertures 26 is evenly spaced apart and distributed between the first 22 and second 24 ends of the distribution tube 20. Finally, the distribution tube 20 may have a length between 12 cm and 18 cm.

An elbow 32 of the feeding member 12 has a primary end 34 and a secondary end 36. Each of the primary 34 and secondary 36 ends of the elbow 32 is open. An exterior wall 38 of the elbow 32 has a bend 40 centrally positioned on the elbow 32. A line extending through each of the primary 34 and secondary 36 ends of the elbow 32 forms a right angle. The secondary end 36 of the elbow 32 insertably receives the second end 24 of the distribution tube 20. The elbow 32 is fluidly coupled to the distribution tube 20.

A coupling tube 42 of the feeding member 12 has a leading end 44 and a following end 46. Each of the leading 44 and following 46 ends of the coupling tube 42 is open. The primary end 34 of the elbow 32 insertably receives the following end 46 of the coupling tube 42. Moreover, the distribution tube 20 forms a right angle with respect to the coupling tube 42. The distribution tube 20 is in fluid communication with the coupling tube 42. The feeding member 12 is one of a pair of the feeding members 48. A pair of caps 50 is each coupled to the first end 22 of the distribution tube 20 of an associated one of the pair of feeding members 48.

A filling member 50 is operationally coupled to the pair of feeding members 48 so the filling member 50 extends upwardly away from the pair of feeding members 48. The filling member 50 is substantially hollow. The filling member 50 receives a fluid fertilizer 52. Additionally, the fluid fertilizer 52 is distributed through the plurality of fluid apertures 26 to the root system 16 of the plant life 18. The pair of feeding members 48 evenly distributes the fluid fertilizer 52 around the root system 16 of the plant life 18.

The filling member 50 includes a fill tube 54 elongated between an upper end 56 and a lower end 58 of the fill tube 54. Each of the upper 56 and lower 58 ends of the fill tube 54 is open. The fill tube 54 may have a length between 20 cm and 25 cm. A joint 60 of the filling member 50 has a first lateral end 62 and a second lateral end 64. Each of the first 62 and second 64 lateral ends of the joint 60 is open

A coupling portion 66 of the joint 60 extends laterally away from a body portion 68 of the joint 60. The coupling portion 66 of the joint is centrally positioned on the body portion 68 of the joint 60. A free end 70 of the coupling portion 66 of the joint 60 is open. The free end 70 of the coupling portion 66 of the joint 60 insertably receives the lower end 58 of the fill tube 54. The upper end 56 of the fill tube 54 is exposed above the support surface 14.

Each of the first 62 and second 64 lateral ends of the joint 60 insertably receives the leading end 44 of the coupling tube 42 of an associated one of the pair of feeding members 48. The pair of feeding members 48 forms a U-shape. Each of the pair of feeding members 48 may be spaced apart a distance between 12 cm and 18 cm. The fill tube 54 extends upwardly from each of the pair of feeding members 48 at an obtuse inside angle. Lastly, the fill tube 54 is in fluid communication with each of the pair of feeding members 48.

In use, the assembly 10 is buried in the support surface 14 in an area where the plant life 18 is to be planted. Further, the assembly 10 is buried so the pair of feeding members 48 is planar with a top surface 74 of the support surface 14. The plant life 18 is planted so the root system 16 of the plant life 18 is positioned between and below the pair of feeding tubes 48. The fluid fertilizer 52 is poured into the upper end 56 of the fill tube 54. The plurality of fluid apertures 26 ensures the fluid fertilizer 52 is distributed directly into the root system 16 of the plant life 18. Thus, the assembly 10 delivers the fluid fertilizer directly to the root system 16 under the support surface 14 and avoids the problem of plant damage at the support surface 14 due to phosphate on the support surface 14 promoting feeding at the support surface 14 instead of through the root system 16. The assembly 10 also prevents the fluid fertilizer 52 from being subjected to run-off due to rain.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A plant life feeding assembly comprising:
a pair of feeding members configured to be positionable within a support surface such that said feeding member is positioned proximate a root system of a plant, each said feeding member being substantially hollow;
each said feeding member having a plurality of fluid apertures extending therethrough;
a filling member operationally coupled to each said feeding member such that said filling member extends upwardly out of said support surface, said filling member being substantially hollow, said filling member receiving a fluid fertilizer such that said fluid fertilizer is distributed through said plurality of fluid apertures to the root system of the plant; and
a pair of caps, each said cap being coupled to an associated one of said feeding members opposite said filling member.

2. The assembly according to claim 1, wherein said feeding member comprises a distribution tube extending between a first end and a second end of said distribution tube, each of said first and second ends of said distribution tube being open.

3. The assembly according to claim 1, wherein said plurality of fluid apertures extends through an outer wall of a distribution tube.

4. The assembly according to claim 1, wherein said plurality of fluid apertures are positioned on a bottom side of an outer wall of a distribution tube, said plurality of fluid apertures being evenly spaced apart and distributed between a first and a second end of said distribution tube.

5. The assembly according to claim 1, wherein an elbow of said feeding member has a primary end and a secondary end, each of said primary and secondary ends of said elbow being open.

6. The assembly according to claim 5, wherein an exterior wall of said elbow has a bend centrally positioned thereon such that a line extending through each of said primary and secondary ends of said elbow forms a right angle.

7. The assembly according to claim 1, wherein a secondary end of an elbow insertably receives a second end of a distribution tube.

8. The assembly according to claim 1, further comprising a coupling tube of said feeding member having a leading end and a following end, each of said leading and following ends of said coupling tube being open.

9. (canceled)

10. (canceled)

11. The assembly according to claim 1, further comprising said filling member comprising a fill tube extending between an upper end and a lower end of said fill tube, each of said upper and lower ends of said fill tube being open.

12. The assembly according to claim 1, further comprising a joint of said filling member having a first lateral end and a second lateral end, each of said first and second lateral ends of said joint being open.

13. The assembly according to claim 12, further comprising a coupling portion of said joint extending laterally away from a body portion of said joint such that said coupling portion of said joint is centrally positioned on said body portion of said joint, a free end of said coupling portion of said joint being open, said free end of said coupling portion of said joint insertably receiving a lower end of a fill tube such that an upper end of said fill tube is exposed above the support surface.

14. The assembly according to claim 1, further comprising each of a first and a second lateral end of a joint insertably receiving a leading end of a coupling tube of an associated one of a pair of feeding members such that said pair of feeding members forms a U-shape, a fill tube extending upwardly from each of said pair of feeding members at an obtuse inside angle.

15. A plant life feeding assembly comprising:
a pair of feeding members configured to be positionable within a support surface such that said feeding member is positioned proximate a root system of a plant, each said feeding member being substantially hollow, each said feeding member comprising;
a distribution tube extending between a first end and a second end of said distribution tube, each of said first and second ends of said distribution tube being open;
said distribution tube having a plurality of fluid apertures extending through an outer wall of said distribution tube, said plurality of fluid apertures being positioned on a bottom side of said outer wall of said distribution tube, said plurality of fluid apertures being evenly spaced apart and distributed between said first end and said second end of said distribution tube;
a pair of caps, each said cap being coupled to an associated one of said feeding members opposite said filling member;
an elbow of said feeding member having a primary end and a secondary end, each of said primary and secondary ends of said elbow being open, an exterior wall of said elbow having a bend centrally positioned thereon such that a line extending through each of said primary and secondary ends of said elbow forms a right angle, said secondary end of an elbow insertably receiving said second end of said distribution tube;
a coupling tube of said feeding member having a leading end and a following end, each of said leading and following ends of said coupling tube being open, said primary end of said elbow insertably receiving said following end of said coupling tube such that said feeding tube forms a right angle with respect to said coupling tube;
a filling member operationally coupled to said feeding member such that said filling member extends upwardly out of said support surface, said filling member being substantially hollow, said filling member receiving a fluid fertilizer such that said fluid fertilizer is distributed through said plurality of fluid apertures to the root system of the plant life, said filling member comprising;
a fill tube extending between an upper end and a lower end of said fill tube, each of said upper and lower ends of said fill tube being open;
a joint of said filling member having a first lateral end and a second lateral end, each of said first and second lateral ends of said joint being open, a coupling portion of said joint extending laterally away from a body portion of said joint such that said coupling portion of said joint is centrally positioned on said body portion of said joint, a free end of said coupling portion of said joint being open, said free end of said coupling portion of said joint insertably receiving said lower end of said fill tube such that said upper end of said fill tube is exposed above the support surface; and
each of said first and second lateral ends of said joint insertably receiving said leading end of said coupling tube of an associated one of said pair of feeding members such that said pair of feeding members forms a U-shape, said fill tube extending upwardly from each of said pair of feeding members at an obtuse inside angle.
